(19) United States
(12) Patent Application Publication
(10) Pub. No.: US 2020/0022863 A1
(43) Pub. Date: Jan. 23, 2020

(54) CASKET PILLOW WITH ADJUSTABLE LOFT

(71) Applicant: Vandor Corporation, RIchmond, IN (US)

(72) Inventors: Justin F. Davis, Richmond, IN (US); Gerald H. Davis, Fountain City, IN (US)

(21) Appl. No.: 16/037,247

(22) Filed: Jul. 17, 2018

(51) Int. Cl. A61G 17/04; A47G 9/10

(52) U.S. Cl. CPC A61G 17/044; A47G 9/10

(57) ABSTRACT

A pillow has adjustable compressibility and/or loft. The pillow includes a casing, an insert pad, and a support member. The insert pad is arranged within the casing. The insert pad includes a plurality of regions arranged atop one another to form a plurality of layers. The support member is arranged within the casing such that at least a portion of the support member is directly interposed between two layers of the insert pad and such that the support member is in direct contact with the two layers of the insert pad.

### FIELD OF THE INVENTION

This invention relates to pillows for use in caskets, and more specifically to casket pillows having adjustable loft.

### BACKGROUND

It is desirable for casket pillows to look substantially similar to typical bed pillows so that the deceased arranged upon the pillows have the appearance of resting peacefully in the casket. Accordingly, it is desirable for casket pillows to appear soft, supportive, and tidy while providing the appropriate amount of compression and loft for display. However, because casket pillows do not need to be comfortable, it is also desirable for pillows used in caskets to be made in a manner that reduces costs.

Pillows vary in terms of their compressibility and their loft. As used herein, “compressibility” refers to a relative amount of change in the volume of a material in response to an applied pressure or force. A higher compressibility refers to a greater change in the volume of the material in response to an applied pressure or force. Accordingly, a pillow having a higher compressibility will exhibit a greater change in volume in response to a set pressure or force than a pillow having a lower compressibility. Put another way, a material that is more compressible will exhibit a greater change in volume in response to a set pressure or force than a material that is less compressible. As used herein, “loft” refers to a relative thickness of a material under an applied pressure or force. A material having a higher loft refers to a material having a greater thickness under an applied pressure or force. Accordingly, a pillow having a higher loft will exhibit a greater height under a set pressure or force than a pillow having a lower loft. The compressibility and loft of a pillow are independent properties. Accordingly, a pillow can have high or low compressibility in combination with high loft or have high or low compressibility in combination with low loft. Additionally, separate materials within the pillow can each have an independent compressibility and/or loft.

A compressible casket pillow is one type of casket pillow that can be made in an economical manner. As in the case of a typical bed pillow, when the head of the deceased is laid on a compressible casket pillow, the casket pillow compresses under the weight of the head. In contrast with typical bed pillows, because the comfort and support provided by casket pillows are not priorities, compressible casket pillows are typically made and filled with less expensive materials than typical compressible bed pillows. One problem with such casket pillows is that the inexpensive materials and construction tend to compress more than in a typical bed pillow. This over-compression results in an unnatural appearance as the head of the deceased sinks too far down into the pillow. If the casket pillow is filled with a stiffer material to address this problem of over-compression, then compression at the center of the pillow, where the head is laid, makes the sides portions of the pillow on either side of the head lift upwardly, which actually accentuates the problem.

A pre-formed casket pillow is another type of casket pillow that can give the deceased the look of resting peacefully in the casket and can be made in an economical manner. A pre-formed casket pillow is less compressible than a compressible pillow, so it avoids the problems of over-compression and deformation mentioned above. Additionally, a pre-formed casket pillow has some shaping or indentations formed in the pillow that help to hold the head of the deceased in a particular position. However, pre-formed casket pillows are typically more expensive than compressible casket pillows due to the use of more expensive materials to provide the necessary structure while also maintaining an appearance of being soft and comfortable. Additionally, pre-formed casket pillows may not be a one-size-fits-all solution. People come in all shapes and sizes, but one pre-formed pillow may not work for various head sizes, head shapes, neck lengths, hair arrangements, etc. For example, indentations in a pre-formed casket pillow that are formed to receive the head and neck of the deceased may be too wide or too long for one person, but too narrow or too short for another. The person arranging the deceased within the casket will have relatively few options to adjust the fit of the deceased with a pre-formed pillow.

It is desirable to provide an inexpensive casket pillow that enables the deceased to be laid in a natural and comfortable looking pose. It is further desirable to provide an inexpensive casket pillow that is easily adjustable so that the person arranging the deceased can fine-tune the compression and loft of the pillow to provide the desired natural and comfortable looking pose.

### SUMMARY

One or more of the embodiments of the present invention provides a casket pillow combination including a casket and a pillow. The casket includes side walls and a base arranged to form an open topped box, and the pillow is arranged in the interior of the open topped box. The pillow includes a casing, an insert pad, and a support member. The insert pad is arranged to form a plurality of layers and is inserted into the casing. The support member is inserted into the casing between two of the layers. The support member is movable to various positions between the layers of the insert pad to adjust the compressibility and the loft of the pillow.

At least one embodiment of the present invention provides a pillow with adjustable loft. The pillow includes a casing, an insert pad, and a support member. The insert pad is arranged to form a plurality of layers and is inserted into the casing. The support member is inserted into the casing between two layers of the insert pad. The support member is movable to various positions between the layers of the insert pad to adjust the compressibility and the loft of the pillow.

At least one embodiment of the present invention provides a method of making a pillow with adjustable loft. The method includes rolling or folding an insert pad so that regions of the insert pad are arranged atop one another in layers. The method further includes inserting the rolled or folded insert pad into a casing. The method further includes inserting a support member into the casing between two layers of the rolled or folded insert pad.

The above-described features and advantages, as well as others, will become more readily apparent to those of ordinary skill in the art by reference to the following detailed description and accompanying drawings.

### BRIEF DESCRIPTION OF THE DRAWINGS

FIG. 1 depicts a perspective view of a casket pillow combination including a casket and a pillow.

FIG. 2 depicts a cross-sectional view of the casket pillow combination of FIG. 1 cut along the line II-II.

FIG. 3 depicts an exploded view of the pillow of FIG. 1 including a casing, an insert pad, and a support member.

FIG. 4A depicts a perspective view of an arrangement of the casing, insert pad, and support member of FIG. 3.

FIG. 4B depicts a perspective view of another arrangement of the casing, insert pad, and support member of FIG. 3.

FIG. 4C depicts a perspective view of another arrangement of the casing, insert pad, and support member of FIG. 3.

FIG. 4D depicts a cross-sectional view of the arrangement of the casing and the insert pad shown in FIG. 4C.

FIG. 4E depicts a perspective view of another arrangement of the casing, insert pad, and support member of FIG. 3.

FIG. 4F depicts a cross-sectional view of another arrangement of the casing, insert pad, and support member of FIG. 3.

FIG. 4G depicts a perspective view of another arrangement of the casing, insert pad, and support member of FIG. 3.

FIG. 5A depicts a top view schematic drawing of the pillow of FIG. 1.

FIG. 5B depicts another top view schematic drawing of the pillow of FIG. 1.

FIG. 6 depicts a cross-sectional view of an arrangement of the casing, insert pad, and support member of FIG. 3 in use.

FIG. 7 depicts another cross-sectional view an arrangement of the casing, insert pad, and support member of FIG. 3 in use.

FIG. 8 depicts one embodiment of an arrangement of the insert pad of FIG. 3.

FIG. 9 depicts an alternative embodiment of an arrangement of the insert pad of FIG. 3.

FIG. 10 depicts another alternative embodiment of an arrangement of the insert pad of FIG. 3.

FIG. 11 depicts a flow chart of a method of making a pillow.

### DETAILED DESCRIPTION

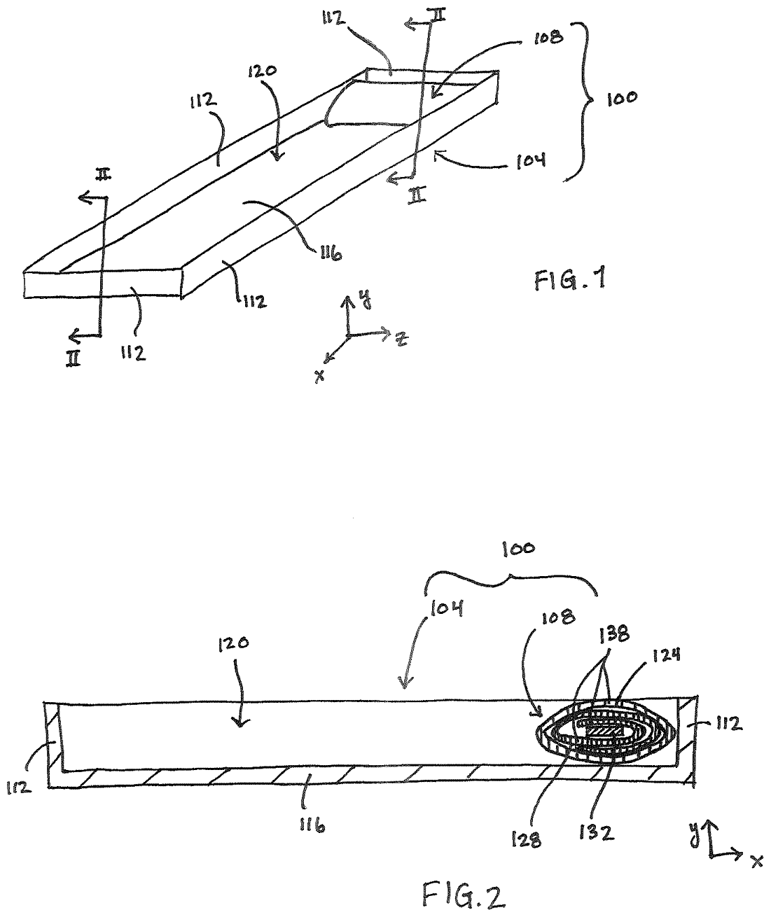

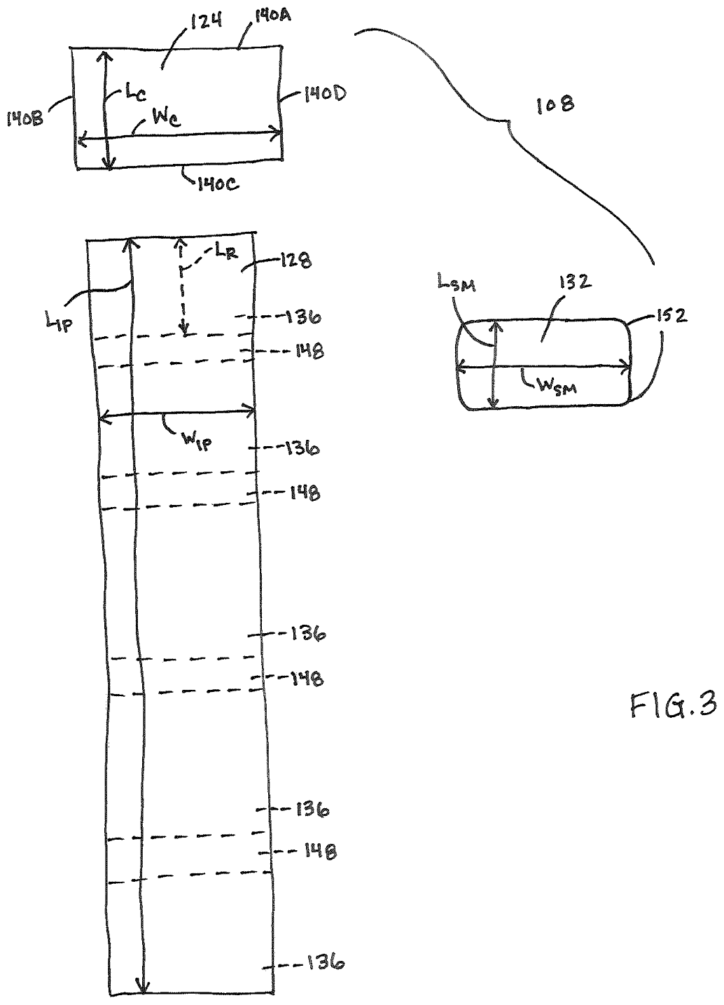

As shown in FIG. 1, the casket pillow combination 100 includes a casket 104 and a pillow 108 arranged within the casket 104. More specifically, the casket 104 includes four walls 112 and a base 116, which are arranged to form an open topped box. In some embodiments, the casket 104 also includes a lid, which is not shown in the drawings. The open topped box has an interior 120, and the pillow 108 is arranged in the interior 120. As shown in more detail in FIG. 2, the pillow 108 includes a casing 124, an insert pad 128 arranged within the casing 124, and a support member 132 arranged within the casing 124. The insert pad 128 includes a plurality of regions 136 (shown in FIG. 3) arranged atop one another such that each region 136 forms a layer 138. As described in more detail below, the support member 132 is arranged between two layers 138 of the insert pad 128 such that the support member 132 is in direct contact with the two layers 138 of the insert pad 128.

FIG. 3 depicts the casing 124, the insert pad 128, and the support member 132 of the pillow 108 separated from one another. The casing 124 is a rectangularly shaped pillow case, substantially similar to a generic rectangularly shaped pillow case that one would use for a standard bed pillow. Accordingly, the casing 124 comprises two substantially rectangular pieces of material that are matched up to one another and sewn together along three sewn sides 140A, 140B, 140C, leaving a fourth side 140D open for insertion and removal of the insert pad 128 and the support member 132. The casing 124 has a casing width W_{C}, which extends from the fourth side 140D to the sewn side 140B that is opposite the fourth side 140D, and a casing length L_{C}, which extends from the first sewn side 140A to the sewn side 140C that is opposite the first sewn side 140A.

When the pillow 108 is arranged in the casket 104, the casing width Wₑ is generally aligned along the z-axis (shown in FIG. 1) and the casing length L_{C} is generally aligned along the x-axis (shown in FIGS. 1 and 2) of the casket pillow combination 100. When the pillow 108 is in use, the neck of the user is generally aligned along the length L_{C} of the pillow 108.

The insert pad 128 of the pillow 108 is an elongated piece of flexible material having a high compressibility. The insert pad material can be, for example, a padding material such as batting. Batting is an advantageous material to use for the insert pad 128 of the pillow 108, because, unlike loose filler, which bunches and clumps unevenly, batting provides a smooth, continuous compressible surface.

The insert pad 128 is a single, continuous piece of the flexible material that is rectangularly shaped, having an insert pad length L_{IP} that is larger than its insert pad width W_{IP}. It is understood, however, that in alternative embodiments the insert pad 128 can have an elongated shape other than a rectangle, which has an insert pad length L_{IP} that is larger than its insert pad width W₁. One advantage of forming the insert pad 128 as a single, continuous piece is that the insert pad 128 can be formed with little to no wasted material. For example, in embodiments where the insert pad 128 is formed of batting, the insert pad 128 can be formed from an elongated piece of batting by making a single cut along the batting, which also requires a minimal amount of labor. Accordingly, making the insert pad 128 as a single, continuous piece is economical in terms of both material and labor.

When the insert pad 128 is inserted into the casing 124, the insert pad width W_{IP} is generally aligned with the casing width W_{C} and the insert pad length L_{IP} is generally aligned with the casing length L_{C}. The insert pad length L_{IP} is larger than the casing length L_{C}, and the insert pad width W_{IP} is equal to or smaller than the casing width W_{C} such that the insert pad 128 can be inserted entirely within the casing 124 when arranged as described below.

Along its length L_{IP}, the insert pad 128 is divided into a plurality of regions 136, which are separated from one another by folds 148. As noted above, the regions 136 are arranged atop one another to form the layers 138 shown in FIG. 2. More specifically, the regions 136 are arranged atop one another by rolling and/or folding the insert pad 128 at the folds 148. The regions 136 have a region length L_{R} that is smaller than the casing length L_{C} such that, when the regions 136 are arranged atop one another, the insert pad 128 can be inserted into the casing 124 through the open side 140D.

The support member 132 of the pillow 108 is a flat panel of material that is generally rectangularly shaped. The flat, smooth surfaces of the support member 132 facilitate insertion and removal of the support member 132 between layers 138 of the insert pad 128 without catching on the material of the insert pad 128. In the embodiment shown, the support member 132 also has rounded corners 152 to further facilitate insertion of the support member 132 between layers 138 of the insert pad 128, as is shown in FIG. 2.

The support member 132 has a support member width W_{SM} and a support member length L_{SM}. When the support member 132 is inserted into the casing 124, the support member width W_{SM} is generally aligned with the casing width W_{C} and the support member length L_{SM} is generally aligned with the casing length L_{C}. The support member width W_{SM} is smaller than the casing width W_{C} and the support member length L_{SM} is smaller than the casing length L_{C} so that the entire support member 132 can be received within the casing 124. Additionally, the support member length L_{SM} is smaller than the region length L_{R}, so that, when the insert pad 128 is arranged within the casing 124, the support member 132 can fit entirely between two of the layers 138 formed by corresponding regions 136 of the insert pad 128.

The support member 132 is formed of a material that is stiffer than the insert pad 128. In other words, the support member 132 is more rigid and less compressible than the insert pad 128. Accordingly, as described in more detail below, when the support member 132 is arranged between two layers 138 of the insert pad 128, the support member 132 increases the rigidity and decreases the compressibility of the pillow 108.

In one embodiment, the support member 132 is a panel of corrugated fiberboard, such as corrugated cardboard, that can be die cut to form the rectangular shape having rounded corners 152. Corrugated fiberboard is an advantageous material to use for the support member 132, because it is lightweight and inexpensive. Furthermore, forming die cut panels of corrugated fiberboard requires relatively little labor. Accordingly, making the support member 132 as a flat die cut panel of corrugated fiberboard is economical in terms of both material and labor.

As noted above, the support member 132 provides a layer of rigidity within the pillow 108 to enable adjustment of the compressibility and/or loft of the pillow 108. For further increased rigidity and strength of the support member 132 made of corrugated fiberboard, the support member 132 is formed such that the flutes of the corrugation are arranged along the support member width W_{SM}. More specifically, corrugated fiberboard consists of a fluted corrugated sheet arranged between two liners. The flutes of the fluted corrugated sheet are arranged linearly extending in one direction across the sheet, and therefore provide pre-formed lines along which the corrugated fiberboard is most likely to bend or buckle. By arranging the corrugated fiberboard such that the flutes are aligned along the support member width W_{SM}, the fiberboard is less likely to bend or buckle under the downward force applied by the head and neck, which is more highly concentrated along the support member length L_{SM}.

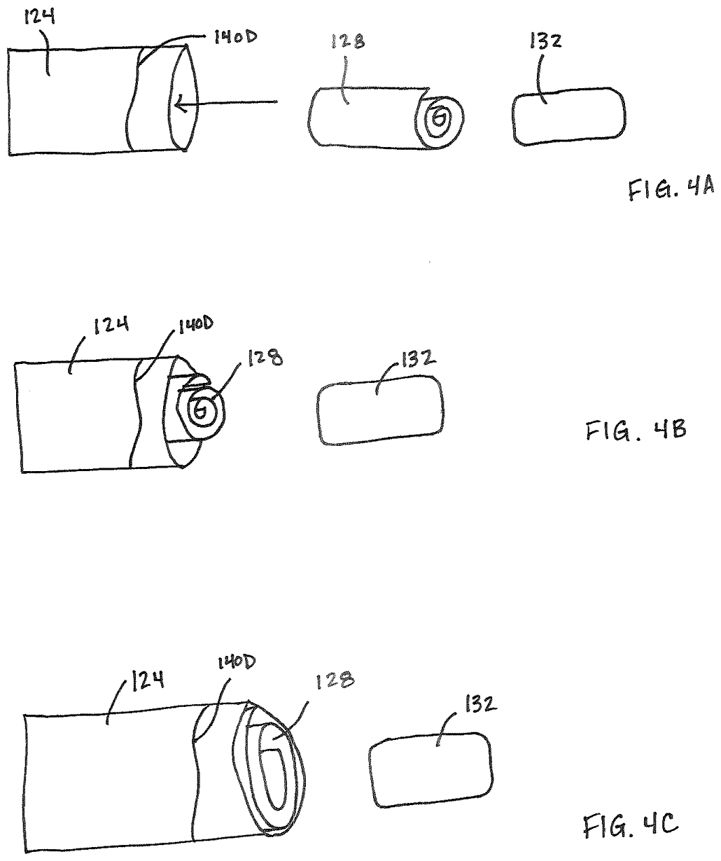

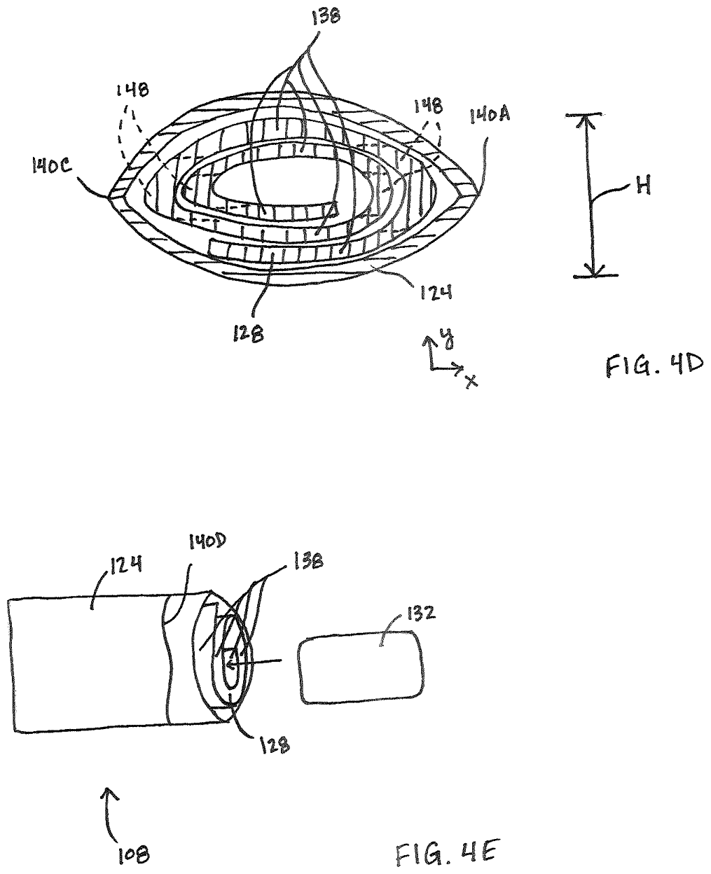

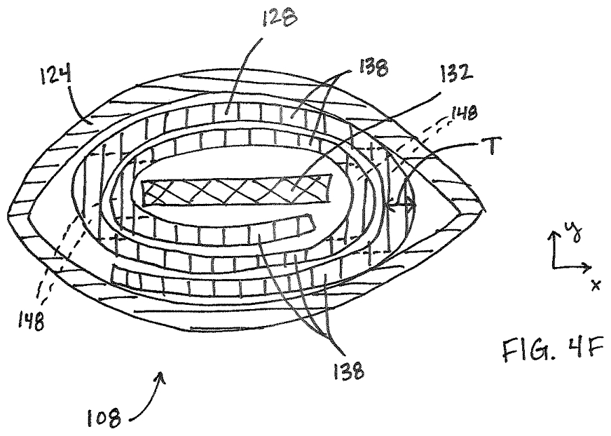

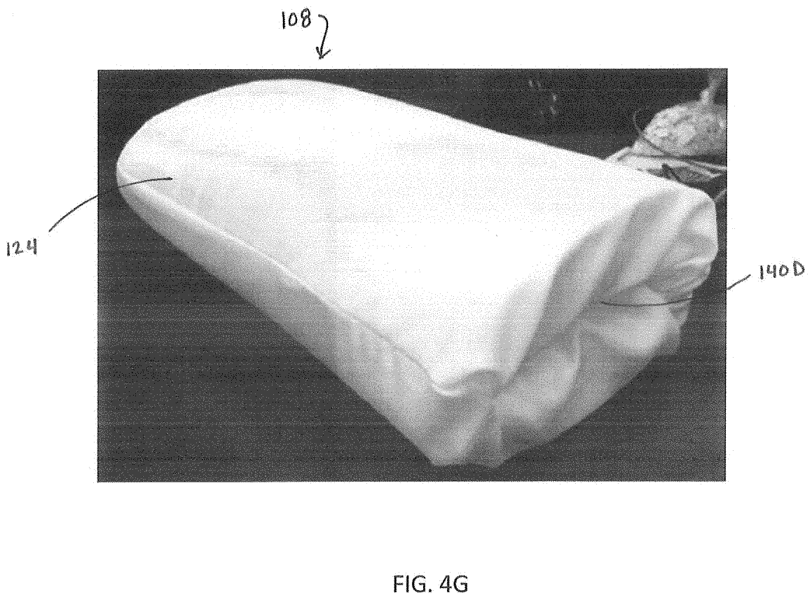

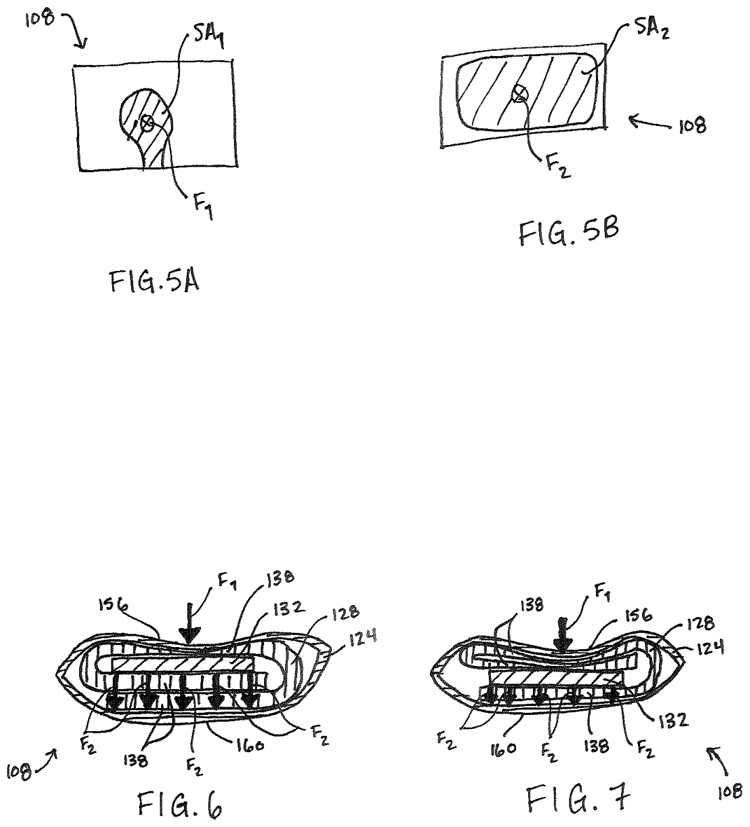

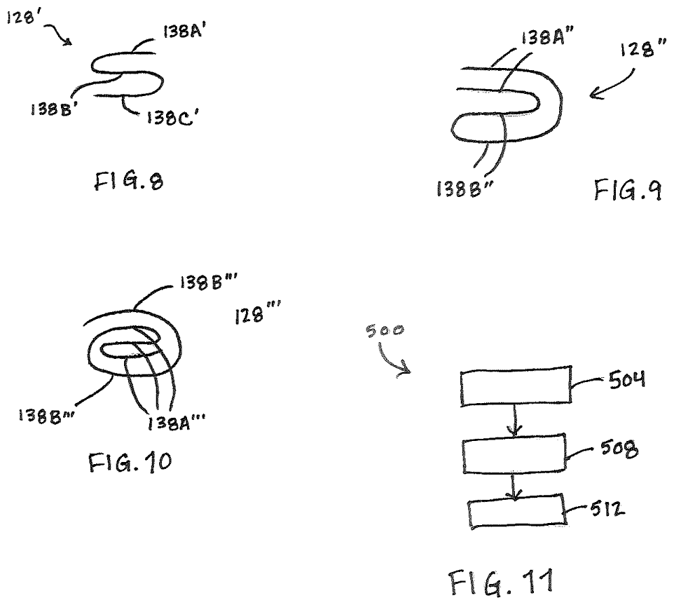

FIGS. 4A-4G depict the arrangement of the insert pad 128 and support member 132 within the casing 124 of the pillow 108. As shown in FIG. 4A, to receive the insert pad 128 and the support member 132, the casing 124 is opened along the open side 140D. In the embodiment shown, the open side 140D is folded back over the casing 124 to facilitate insertion of the insert pad 128 and support member 132. The insert pad 128 is rolled and/or folded along its insert pad length L_{IP} (shown in FIG. 3) so that the length and width of the rolled and/or folded insert pad 128 are smaller than the casing length L_{C} and width W_{C} (shown in FIG. 3) and so that the insert pad 128 can be inserted through the open side 140D and into the casing 124, as shown in FIG. 4B.

Because the casing 124 is rectangularly shaped, and because the insert pad 128 is formed of a compressible and flexible material, once the rolled and/or folded insert pad 128 is inserted into the casing 124 and is released, the insert pad 128 unfurls and relaxes to generally conform to the interior of the rectangular shape formed by the casing 124, as shown in FIG. 4C. Thus, as shown in FIG. 4D, the regions 136 (shown in FIG. 3) of the insert pad 128 flatten into the layers 138 and fill out the rectangular shape of the casing 124. The layers 138 are arranged atop one another along a height H of the pillow 108, which is aligned along the y-axis, and the folds 148, which are arranged between the regions 136, are nested inside one another and are generally aligned with the opposite sewn sides 140A, 140C of the casing 124.

As shown in FIG. 4E, the support member 132 is then inserted between two layers 138 of the insert pad 128 to complete the pillow 108, as shown in FIG. 4F. When the support member 132 is inserted in between the layers 138 of the insert pad 128, it is possible that some portion of the support member 132 may be arranged in the folds 148, and therefore not directly between the layers 138. Additionally, it is possible that some layers 138, such as the innermost and outermost layers, may not extend as far along the x-axis as other layers 138. In other words, the entirety of the support member 132 may not be arranged directly between layers 138 of the insert pad 128. However, at least a portion of the support member 132 is directly interposed between two layers 138 of the insert pad 128 such that the support member 132 is in direct contact with the two layers 138 of the insert pad 128.

To more clearly illustrate the separate elements of the pillow 108, the drawing shown in FIG. 4F does not depict the support member 132 in contact with the layers 138 of the insert pad 128, but instead includes some space between the casing 124, the layers 138 of the insert pad 128 and the support member 132. However, this representation is for clarity of the arrangement of the elements of the pillow 108, and clearly shows that there is no element or material arranged between the support member 132 and the layers 138 of the insert pad 128 or between the insert pad 128 and the casing 124. In actual construction, the insert pad 128 is in direct contact with the casing 124, and the support member 132 is in direct contact with the two layers 138 of the insert pad 128 between which the support member 132 is inserted.

One advantage of arranging the support member 132 between two layers 138 of the insert pad 128 is that the edges of the support member 132 that span the support member width W_{SM} between rounded corners 152 are arranged within folds 148 of the insert pad 128, as shown in FIG. 4F. This arrangement prevents these narrow edges of the support member 132 from pressing against the inside of the casing 124, which would be both visible and tangible from outside the casing 124 and interfere with the soft, comfortable, and tidy appearance and feel of the pillow 108.

Once the pillow 108 is completed, the open side 140D of the casing 124 can be folded over the insert pad 128 and the support member 132 and tucked in between the layers 138 of the insert pad 128 or between the insert pad 128 and the support member 132 to cover the insert pad 128 and the support member 132 and give the pillow 108 a tidy, finished appearance, as shown in FIG. 4G.

The number of layers 138 formed by the insert pad 128 depends on the relative dimensions of the insert pad 128 and the casing 124 and on the material properties of the insert pad 128, such as the flexibility and compressibility. For example, the longer the insert pad length L_{IP} relative to the casing length L_{C}, the more times the insert pad 128 can be rolled and/or folded within the casing 124, therefore forming more layers 138. Additionally, the more flexible and compressible the material of the insert pad 128, the more easily the insert pad 128 can be manipulated, and the greater the number of layers 138 that can be fit into the casing 124. However, the number of layers 138 that can be formed within the casing 124 is limited by the thickness T of the insert pad 128 (shown in FIG. 4F). The greater the thickness T of the insert pad 128, the fewer the number of layers 138 of the insert pad 128 that will fit within the casing 124. Conversely, the smaller the thickness T of the insert pad 128, the greater the number of layers 138 of the insert pad 128 that can be fit into the casing 124.

When the support member 132 is inserted between layers 138 of the insert pad 128, at least one layer 138 is arranged above the support member 132 and at least one layer 138 is arranged below the support member 132. The orientation terms “above” and “below” are used to indicate relative vertical positions along the y-axis shown in the figures. The compression and/or loft of the pillow 108 can be adjusted by changing the number of layers 138 above and below the support member 132. In other words, the compression and/or loft of the pillow 108 can be selected by selecting which layers 138 to insert the support member 132 between.

FIGS. 5A and 5B provide schematic representations of the pillow 108 to illustrate how the position of the support member 132 impacts the compression and/or loft of the pillow 108. In use, a head and neck resting on the pillow 108 applies a downward force F₁, which is directed in a direction into the drawing in FIGS. 5A and 5B. Because the casing 124 and the insert pad 128 are flexible and have a relatively high compressibility, the downward force F₁ is generally concentrated at the location of the head and neck. Thus, the downward force F₁ is concentrated over a surface area SA₁ (shown in FIG. 5A), beneath the head and neck, which is small relative to the surface area of the entire pillow 108. This relatively concentrated downward force is indicated in the drawings by reference numeral F₁.

Because the support member 132 is more rigid and less compressible than the insert pad 128 and the casing 124, the support member 132 distributes the downward force F₂ over the entire surface area SA₂ (shown in FIG. 5B) of the support member 132. This surface area SA₂ of the support member 132 is larger than the surface area SA₁ at the location of the head and neck. This distributed downward force is indicated in the drawings by reference numeral F₂. Accordingly, layers 138 of the insert pad 128 that are arranged above the support member 132 compress freely in the surface area SA₁ under the downward force F₁ down to the support member 132. The support member 132 distributes the downward force F₁ over the surface area SA₂ of the support member 132, and then applies that distributed downward force F₂ over the surface area SA₂ to the layers 138 of the insert pad 128 that are arranged below the support member 132.

FIGS. 6 and 7 depict two positions in which the support member 132 can be inserted to select the compressibility and/or loft of the pillow 108. FIG. 6 depicts the support member 132 arranged in a first position, nearer to a top 156 of the pillow 108, and FIG. 7 depicts the support member 132 in a second position, nearer to a bottom 160 of the pillow 108. In the first position, one layer 138 is arranged above the support member 132 and two layers 138 are arranged below the support member 132. In other words, the support member 132 is arranged between the top and middle layers 138 of the insert pad 128 and is in direct contact with the top and middle layers 138 of the insert pad 128. In the second position, two layers 138 are arranged above the support member 132 and one layer 138 is arranged below the support member 132. In other words, in the second position, the support member 132 is arranged between the middle and bottom layers 138 of the insert pad 128 and is in direct contact with the middle and bottom layers 138 of the insert pad 128. The support member 132 is easily movable between these two positions, and can also be removed entirely from the pillow 108, by simply inserting and removing the support member 132 between the layers 138 of the insert pad 128.

As shown in FIG. 6, inserting the support member 132 in the first position, nearer to the top 156 of the pillow 108, provides fewer layers 138 of the insert pad 128 arranged above the support member 132 and more layers 138 of the insert pad 128 arranged below the support member 132. Accordingly, fewer layers 138 of the insert pad 128 will compress freely in the relatively small surface area SA₁ (shown in FIG. 5A) before the concentrated downward force F₁ is distributed by the support member 132 over the relatively large surface area SA₂ to the remaining layers 138 below the support member 132. This results in the pillow 108 exhibiting less compressibility and a higher loft.

Conversely, as shown in FIG. 7, inserting the support member 132 in the second position, nearer to the bottom 160 of the pillow 108, provides more layers 138 of the insert pad 128 arranged above the support member 132 and fewer layers 138 of the insert pad 128 arranged below the support member 132. Accordingly, more layers 138 of the insert pad 128 will compress freely in the relatively small surface area SA₁ (shown in FIG. 5A) before the concentrated downward force F₁ is distributed by the support member 132 over the relatively large surface area SA₂ to the remaining layers 138 below the support member 132. This results in the pillow 108 exhibiting more compressibility and a lower loft.

In the present disclosure, the insert pad 128 forms at least three layers 138 within the casing 124. Forming three layers 138 with the insert pad 128 provides two different positions that the support member 132 can be inserted between layers 138 of the insert pad 128. (For example, the position shown in FIG. 6 and the position shown in FIG. 7.) It is understood, however, that in alternative embodiments, the insert pad 128 can form more or fewer than three layers 138 within the casing 124. Forming two layers 138 with the insert pad 128 provides only one position that the support member 132 can be inserted between layers 138 of the insert pad 128. Accordingly, in embodiments having only two layers 138, the pillow 108 either includes or excludes the support member 132. In this case, the compressibility of the pillow 108 is decreased and the loft of the pillow 108 is increased by the inclusion of the support member 132. In embodiments having more than three layers 138, there are more possible positions for the support member 132, and therefore more possibilities for adjusting the loft and/or compressibility of the pillow 108 in the manner described above. The number of positions in which the support member 132 can be inserted is one less than the number of layers 138 formed by the insert pad 128.

As described above and shown in the embodiments of FIGS. 2, 4A-4F, 6, and 7, the insert pad 128 is rolled to form the layers 138. It is to be understood, however, that in alternative embodiments, the insert pad 128 can be folded along the folds 148, or folded along some folds 148 and rolled along others, to form the layers 138. For example, as shown in FIG. 8, the insert pad 128′ can be folded in an accordion style, where a first layer 138A′ is doubled back on an adjacent second layer 138W, and the second layer 138W is doubled back on an adjacent third layer 138′C. As another alternative, as shown in FIG. 9, the insert pad 128″ can be folded in half a first time to form two first layers 138A″ and then folded in half a second time to form two second layers 138B″. As another alternative, as shown in FIG. 10, the insert pad 128′″ can be folded in the accordion style to form innermost layers 138A′″ and then rolled to form outermost layers 138B′″. It is possible to fold and/or roll the insert pad 128 in any manner which results in a plurality of layers 138 which can be inserted into the casing 124 in the manner described above.

A method 500 of making a pillow for use in a casket, such as pillow 108, is shown in FIG. 11. As shown, at step 504, making the pillow first includes arranging an insert pad, such as insert pad 128, such that a plurality of regions, such as regions 136, of the insert pad are arranged atop one another to form a plurality of layers, such as layers 138. In at least one embodiment, arranging the insert pad includes folding the insert pad. Once the insert pad has been arranged, making the pillow includes inserting the arranged insert pad into a rectangularly shaped casing, such as casing 124 (step 508).

Once the arranged insert pad has been inserted into the casing, making the pillow includes inserting the support member between two layers of the insert pad such that the support member is in direct contact with the two layers of the insert pad (step 512). As described above, the support member is less compressible than the insert pad.

Accordingly, making the pillow includes determining which two layers of the insert pad between which to insert the support member. This determination is made based on the desired compressibility and/or loft of the pillow. Accordingly, one way to determine which two layers of the insert pad to insert the support member between is based on a desired amount of compressibility of the pillow. Another way to determine which two layers of the insert pad to insert the support member between is based on a desired amount of loft of the pillow.

As described above with respect to the pillow 108 shown in FIGS. 6 and 7, at least one layer of the insert pad is arranged atop the inserted support member, forming an upper portion of the pillow, and at least one layer of the insert pad is arranged below the inserted support member, forming a lower portion of the pillow. Thus, one way to determine which two layers of the insert pad to insert the support member between is based on a desired amount of compressibility of the upper portion of the pillow. For a higher desired compressibility of the upper portion of the pillow, the support member will be inserted beneath a higher number of layers of the insert member. For a higher desired loft, the upper portion of the pillow will be less compressible. Accordingly, for a higher desired loft, the support member will be inserted beneath a lower number of layers of the insert member.

The method 500 can be repeated as many times as desired based on different determinations of the desired amount of compressibility and/or loft of the pillow. One reason the pillow 108 is especially useful in a pillow casket combination 100 is the ease of adjustability of the compressibility and/or loft of the pillow 108. Because adjusting the compressibility and/or loft only requires determining which two layers 138 of the insert member 128 between which to insert the support member 132, the person arranging the deceased on the pillow 108 can easily adjust and readjust the pillow 108 to provide the most comfortable and natural arrangement of the neck and head of the deceased in the casket 104.

However, in alternative embodiments, the pillow 108 can be used without the casket 104 or separately from the casket pillow combination 100. Even in embodiments where the pillow 108 is used alone, the pillow 108 retains its benefits of having easily adjustable compression and/or loft. Thus, the pillow 108 is just as useful in many alternative instances where an economical pillow having easily adjustable compression and/or loft is desirable.

For example, the pillow 108 can be used as a bed pillow in one's home. In this case, the pillow user can easily adjust the compressibility and/or loft of the pillow 108 for different circumstances. A user may desire a higher loft for tasks such as reading or watching television, and a lower loft for sleeping. Additionally, the user's comfort may vary with higher and lower compressibility on different days. For example, if a user has a stiff neck temporarily, the user can temporarily adjust the compressibility of the pillow. This can also prevent a user from having to purchase a variety of pillows having different compressibilities and/or lofts, because one pillow can be adjusted as desired.

Additionally, the pillow 108 having adjustable compressibility and/or loft can be beneficial for hotels, hospitals, airplanes, cruise ships, and other places where persons sleep for a limited amount of time. Rather than having to provide a wide variety of pillows with varying compressibilities and/or lofts to meet their various guests or patient's needs, it is possible for hotels, hospitals, etc. to include adjustable pillows, which each guest or patient can adjust to fit their own comfort. For airplanes, where it is important that pillows provided to customers are very economical, it is possible to make the pillows from inexpensive materials, and to make the pillows smaller than a standard bed pillow, which will require even less materials. For hotels, cruise ships, and other instances where increased comfort and a more luxurious aesthetic may be desirable, it is possible to make the pillow 108 having a casing, insert pad, and/or support member made from more comfortable or visually appealing materials that may be more expensive. In other words, the pillow 108 can be made from a variety of different materials to meet different industry needs for balancing comfort, aesthetic, and cost.

The pillow 108 can also be useful for emergency shelters, for example in the case of natural disasters. Because the pillow 108 can be made with low cost materials and processing, it is economically viable for emergency service providers to offer a comfortable pillow to displaced persons.

Similarly, the pillow 108 can be useful for camping, because the pillow can be easily adjusted to make sleeping on a variety of ground surfaces more comfortable. Additionally, because of the low cost of materials and processing required to make the pillow, it is easy to replace the pillow if its use in camping environments shortens its longevity. Furthermore, because the pillow 108 is made of lightweight and compressible materials, it is ideal for backpacking, where the weight and volume of each item carried is sought to be minimized.

Additionally, the simple construction and lightweight, inexpensive materials of the pillow 108 enable low cost shipping and storage of the pillows 108, which further reduces the costs for purchasers of the pillows. For example, the pillow 108 can easily be compressed and shrink wrapped to maximize density to lower freight and storage costs, especially when shipping and/or storing in bulk.

Of course, numerous other adaptations are possible. Moreover, there are advantages to individual advancements described herein that may be obtained without incorporating other aspects described above. Therefore, the spirit and scope of the appended claims should not be limited to the description of the preferred embodiments contained herein.

What is claimed is:

1. A pillow with adjustable loft, the pillow comprising:
a casing;
an insert pad arranged within the casing, the insert pad including a plurality of regions arranged atop one another to form a plurality of layers; and
a support member arranged within the casing such that at least a portion of the support member is directly interposed between two layers of the insert pad and such that the support member is in direct contact with the two layers of the insert pad.

2. The pillow of claim 1, wherein:
the plurality of regions are formed on a continuous piece of material that is folded such that folds connect the regions.

3. The pillow of claim 1, wherein:
the casing is rectangularly shaped, having four straight sides.

4. The pillow of claim 1, wherein:
the support member is a flat panel of material.

5. The pillow of claim 1, wherein:
the support member is less compressible than the insert pad.

6. The pillow of claim 1, wherein:
the support member is movable between a first position and a second position;
when in the first position, the support member is arranged between a first layer and a second layer of the plurality of layers of the insert pad; and
when in the second position, the support member is arranged between the second layer and a third layer of the plurality of layers of the insert pad.

7. The pillow of claim 6, wherein:
when in the first position, the support member is in direct contact with the first layer and the second layer; and
when in the second position, the support member is in direct contact with the second layer and the third layer.

8. The pillow of claim 1, wherein:
the support member is movable between a first position, a second position, and a third position;
when in the first position, the support member is arranged between a first layer and a second layer of the plurality of layers of the insert pad;
when in the second position, the support member is arranged between the second layer and a third layer of the plurality of layers of the insert pad; and
when in the third position, the support member is arranged between the third layer and a fourth layer of the plurality of layers of the insert pad.

9. The pillow of claim 8, wherein:
when in the first position, the support member is in direct contact with the first layer and the second layer;
when in the second position, the support member is in direct contact with the second layer and the third layer; and
when in the third position, the support member is in direct contact with the third layer and the fourth layer.

10. A casket pillow combination, comprising:
a casket including four side walls and a base, the side walls and the base arranged as an open topped box having an interior; and
a pillow arranged in the interior, the pillow comprising:
a casing;
an insert pad arranged within the casing, the insert pad including a plurality of regions arranged atop one another to form a plurality of layers; and
a support member arranged within the casing such that at least a portion of the support member is directly interposed between two layers of the insert pad and such that the support member is in direct contact with the two layers of the insert pad.

11. The combination of claim 10, wherein:
the plurality of regions are formed on a continuous piece of material that is folded such that folds connect the regions.

12. The combination of claim 10, wherein:
the support member is a flat panel of material.

13. The combination of claim 10, wherein:
the support member is less compressible than the insert pad.

14. The combination of claim 10, wherein:
the support member is movable between a first position and a second position;
when in the first position, the support member is arranged between a first layer and a second layer of the plurality of layers of the insert pad; and
when in the second position, the support member is arranged between the second layer and a third layer of the plurality of layers of the insert pad.

15. The combination of claim 14, wherein:
when in the first position, the support member is in direct contact with the first layer and the second layer; and
when in the second position, the support member is in direct contact with the second layer and the third layer.

16. A method of making a pillow for use in a casket, the method comprising:
arranging an insert pad such that a plurality of regions of the insert pad are arranged atop one another to form a plurality of layers;
inserting the insert pad into a rectangularly shaped casing; and
inserting a support member into the casing between two layers of the insert pad such that the support member is in direct contact with the two layers of the insert pad,
wherein layers of the insert pad arranged atop the inserted support member form a first portion of the pillow and layers of the insert pad arranged below the inserted support member form a second portion of the pillow, and
wherein the support member is less compressible than the insert pad.

17. The method of claim 16, further comprising:
determining which two layers of the insert pad to insert the support member between based on a desired amount of compressibility of the first portion of the pillow.

18. The method of claim 16, further comprising:
determining which two layers of the insert pad to insert the support member between based on a desired number of layers forming the first portion of the pillow.

19. The method of claim 18, further comprising:
determining the desired number of layers forming the first portion of the pillow based on a desired amount of compressibility of the first portion of the pillow.

20. The method of claim 16, wherein:
arranging the insert pad includes folding the insert pad.
